(19) United States
(12) Patent Application Publication
(10) Pub. No.: US 2013/0331167 A1
(43) Pub. Date: Dec. 12, 2013

(54) Apparatus and Method for a Game with Connectable Game Elements

(71) Applicant: Genesis Gaming, Inc., Henderson, NV (US)

(72) Inventors: Steven W. Meistrich, Henderson, NV (US); Thai Mary, Henderson, NV (US)

(73) Assignee: Genesis Gaming, Inc., Henderson, NV (US)

(21) Appl. No.: 13/897,488

(22) Filed: May 20, 2013

Related U.S. Application Data
(60) Provisional application No. 61/657,949, filed on Jun. 11, 2012.

(51) Int. Cl. G07F 17/34

(52) U.S. Cl. CPC G07F 17/34
USPC 463/20

(57) ABSTRACT

An apparatus and method for a game of play for use in a casino establishment, or on a general purpose computing device for offering games with multiple outcomes and including connectable game elements. A base game, or an outcome on a base game that triggers a sub-game or a bonus game involves establishing connections between connectable game elements where the orientation of ends of the elements are in alignment. Alignment and connection of the connectable game elements results in awards to players. The apparatus and method are offered on electronic gaming machines such as slot machines and video poker machines, but may also be deployed on other devices such as on a general purpose computing device or mobile telephone in stand-alone form or connected to a network, such as the internet.

### RELATED APPLICATION INFORMATION

This application claims priority benefit from U.S. Provisional Application No. 61/657,949, filed on Jun. 11, 2012.

### COPYRIGHT NOTICE

Portions of this disclosure contain material in which copyright is claimed by the applicant. The applicant has no objection to the copying of this material in the course of making copies of the application file or any patents that may issue on the application, but all other rights whatsoever in the copyrighted material are reserved.

### BACKGROUND

Electronic gaming machines (“EGMs”) offer a variety of games such as slot games, video poker games, roulette games, keno games and other types of wagering games that are commonly deployed at a casino for use by players. Play on the EGMs typically requires the player to place a wager on the outcome of the game. The games are programmed with a predefined set of outcomes including one or more winning outcomes and one or more losing outcomes. The player is awarded for a winning outcome and receives no award for a losing outcome.

Historically, the simple format of game play with a predefined set of outcomes has been appealing to players even though there are typically more losing outcomes than winning outcomes. However, game designers, players and operators of games are always striving to find appealing features and game functionality that will generate player excitement and increase, or at least maintain the interest of the player. Special awards, multipliers, bonus games and bonus features have become more and more popular in recent years as EGMs have grown more sophisticated, and players enjoy extending play with exciting new features and functionality.

The present invention defines a system and method that adds excitement and a new form of entertainment to the play of wagering games. It does so by offering a fun and captivating game feature which may be implemented in a base game or a bonus game. Like other games played on an EGM, the player places an initial wager to play. A random number generator (“RNG”) on the EGM generates an outcome and that outcome is displayed on the EGM display to the player. The base game may display the connectable game elements where the orientation of the elements creates different alignments to generate wins. Or, in the event the winning combination on the base game includes certain trigger elements, the player is provided with an opportunity to enter a sub-game or bonus game that includes connectable game elements where the orientation of the elements creates different alignments. Alignment and connection of the connectable elements results in additional awards to players. It is also possible to implement the connectable game element feature in play on both the base and bonus games.

### BRIEF DESCRIPTION OF THE DRAWINGS

For a better understanding of the present invention, and to show more clearly how it functions, reference will now be made, by way of example, to the accompanying drawings. The drawings show embodiments of the present invention in which:

FIG. 1A shows an electronic gaming machine for playing a game;

FIGS. 1B-1F show computing devices for playing a game;

FIG. 2 shows an electronic gaming machine for playing a game and connected to a network controlled by a server based system;

FIG. 3A shows a group of electronic gaming machines on a network connected to a server based system and an external system;

FIG. 3B shows a group of general purpose computing devices on a network connected to a server based system;

FIGS. 4A-4B show flow charts of game play where the player plays a game with connectable game elements;

FIGS. 5A-D shows a set of connectable game elements and example positions between adjacent connectable game elements;

FIGS. 6A-6B show one example of screen shots of game play where the player plays a game with connectable game elements;

FIGS. 7A-7B show another example of screen shots of game play where the player plays a game with connectable game elements;

FIGS. 8A-8B show another example of screen shots of game play where the player plays a game with connectable game elements;

FIG. 9 shows an example of a multiplier applied to a game where the player plays a game with connectable game elements; and

FIG. 10 shows an example of free spin opportunities available to a player where the player plays a game with connectable game elements.

### DETAILED DESCRIPTION OF THE INVENTION

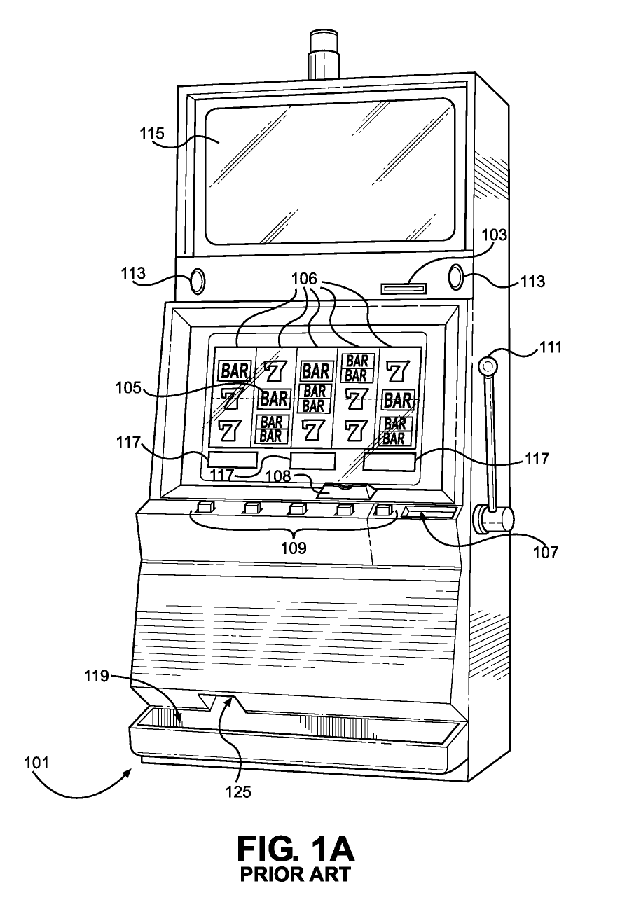

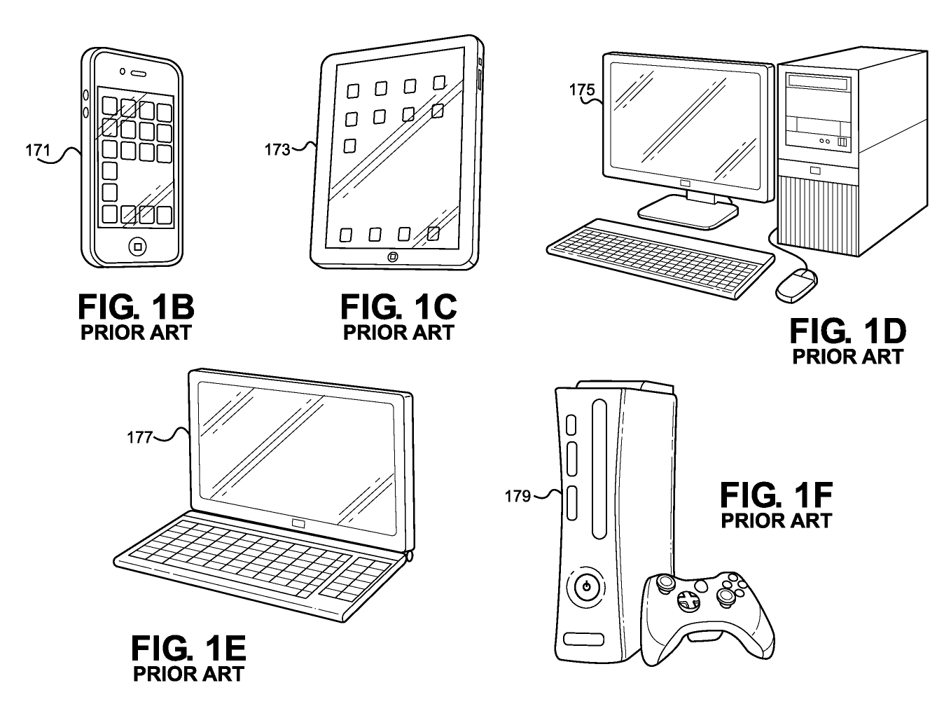

The present invention will now be described more fully with reference to the accompanying drawings. It should be understood that the invention may be embodied in many different forms and should not be construed as limited to the embodiments set forth herein. Throughout FIGS. 1-10, like elements of the invention are referred to by the same reference numerals for consistency purposes.

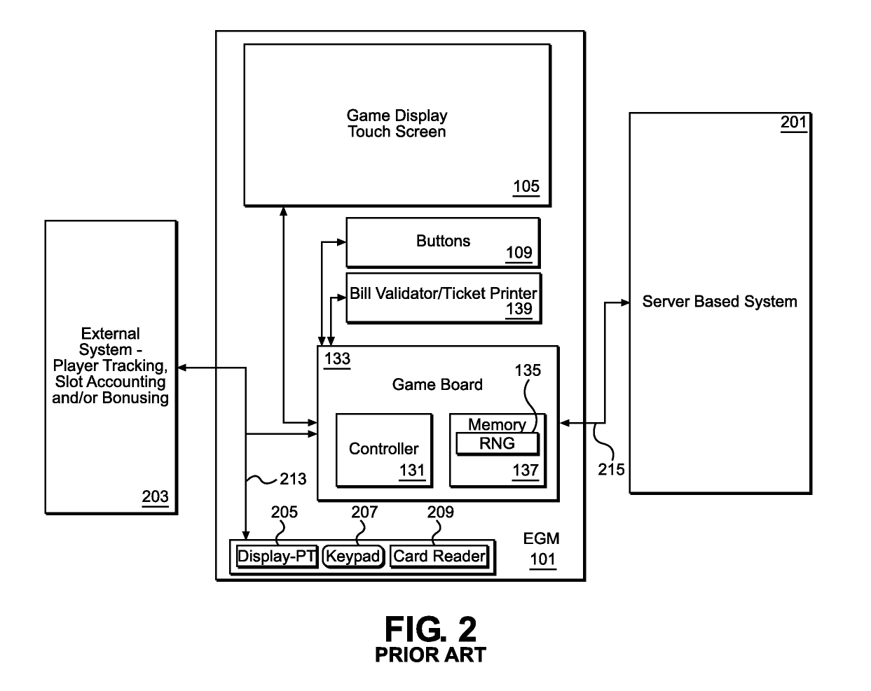

FIG. 1A shows a prior art electronic gaming machine (“EGM”) 101 with a number of components. A display 105 is used to show game play and resulting outcomes, and may be in the form of a video display (shown), or alternatively, physical reels. Touch screen displays are included on most EGMs and provide a flexible interface for operation of EGM 101, including displaying symbols 106 during play. Other components include a bill validator/ticket printer (see FIG. 2) and a coin acceptor that are both housed inside EGM 101 into which bills may be inserted through bill slot 107 and coins may be inserted through coin head 108, respectively. Buttons 109 on the exterior of EGM 101 are used to control certain EGM operations in conjunction with touch screen display 105. A handle 111 may be used to initiate play of a game and speakers 113 are used to provide sounds in conjunction with game play and other EGM operations. EGMs further include a top box 115 for displaying pay tables, artwork, advertising or other types of information either on fixed glass or on other displays such as an integrated video panel. Top box 115 may be fitted with a liquid crystal display (“LCD”) screen to permit aspects of game play from either a base game or a secondary game to be shown in top box 115. Meters 117 for tracking credits available for play, amount won on a particular play, number of coins bet, number of paylines played and other amounts are positioned near the bottom of screen 105. A coin tray 119 at the bottom of EGM 101 is used to catch coins as they are dispensed to a player. It is also common for EGM 101 to include a ticket-in, ticket-out (“TITO”) component that may be part of the bill validator housed inside of EGM 101 that may accept bar coded credits through slot 107 and for which the value of the credits is displayed on meters 117 upon a ticket being inserted. A TITO component may also print and dispense tickets with a bar coded value from EGM 101.

FIGS. 1B-1F show a number of general purpose computing devices which may be used to play a game. These figures show a smartphone 171 in FIG. 1B which may be an Apple iPhone 4S® as pictured, or any other mobile phone type device. A tablet computer 173 is shown in FIG. 1C which may be an Apple iPad 3® as pictured, or any other tablet computing device. A desktop computer 175 is shown in FIG. 1D which may be a Lenovo® machine as pictured, or any other desktop computer. A laptop computer 177 is shown in FIG. 1E which may be a Lenovo® computer or any other laptop computer. And, a home video gaming device 179 is shown in FIG. 1F which may be a Microsoft Xbox® system or any other home video system. Other types of network connected devices could also be used to play games including portable video gaming devices such as a Sony PSP®, a Nintendo GameBoy®, or an internet connected television with a browser or app capabilities. Any of these devices is capable of playing a game, including a wagering game, through an app loaded onto the device or through a website accessible using a browser on the device. In the case of the networked game, payment may be made by credit card, Paypal® or another payment service. The RNG is run securely on server based system 201 (See FIG. 2) and then delivers the outcomes over the internet to be displayed on the general purpose computing device. It should also be understood that the game may be played for fun without a wager, or using promotional or “fun” credits that do not have monetary value.

FIG. 2 is a block diagram of EGM 101 connected to a server based system 201 and showing certain internal components of EGM 101. All operational functions of EGM 101 are controlled by a controller 131 such as a microprocessor housed inside EGM 101 that is resident on a game board 133. The controller executes instructions that include operation of a random number generator 135 (“RNG”) that is usually implemented in software and stored in a memory 137. The internal components of EGM 101 are well known to those of ordinary skill in the art. Game outcomes are determined based on the results corresponding to the numbers selected by RNG 135. A bill validator 139 also has ticket printing capabilities. Bill validator 139 accepts currency in the form of bills, or tickets from a player and adds credit to meters 117 on EGM 101.

An external system 203 such as a player tracking system, a slot accounting system or a bonusing system may also be connected to EGM 101. These types of systems are typically connected to EGM 101 either through a separate interface board (not shown) or directly integrated with the components of EGM 101 including but not limited to game board 133. A player tracking system may also include other components installed on EGM 101 such as a player tracking display 205, a keypad 207 and a card reader 209. These components allow for direct interaction between external system 203 and the player to receive information from the player on keypad 207 or through information on a card inserted into card reader 209, and to display information to the player on display 205. A network is established between external system 203 and EGM 101 by network connection 213. The network may be connected to all EGMs 101 in a casino or any smaller subset of EGMs 101.

Server based system 201 is also connected to EGMs 101 by a network connection 215 which may be a separate connection or on a connection to the same network as external system 203. Server based system 201 may have one or more individual servers tasked with different functions such as communicating with a player at EGM 101 to fulfill requests, delivering services such as television shows or other content, or a host of other information.

In FIG. 2, EGM 101 is shown as a casino gaming device of the type depicted in FIG. 1A. It should be understood that any one or more of the general purpose computing devices—smartphone 171, tablet computer 173, desktop computer 175, laptop computer 177, or home video gaming system 179 shown in FIGS. 1B-1F—could be placed on a network connected to server based system 201 and used to deliver a game with connectable game elements. For purposes of this specification, reference to one or more EGMs 101 in an environment using a limited access intranet of the type typically found in a casino would also apply to one or more general purpose computing devices with a secure connection to a server over the internet and not involving a physical casino property at all, and which may or may not require a wager or payment to play.

It will be understood that the type of network over which data is communicated can be one of several different types of networks. These networks include a Local Area Network (LAN), Wide Area Network (WAN), an intranet or the Internet. Other proprietary networks could also be used without departing from the principles of the invention. This would include such networks as a Windows network or an Ethernet network.

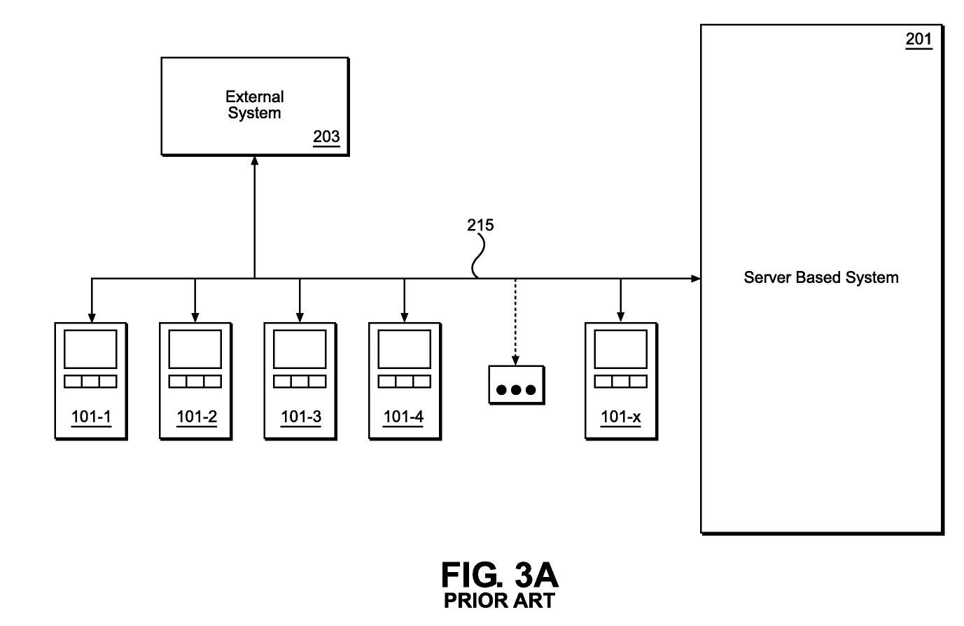

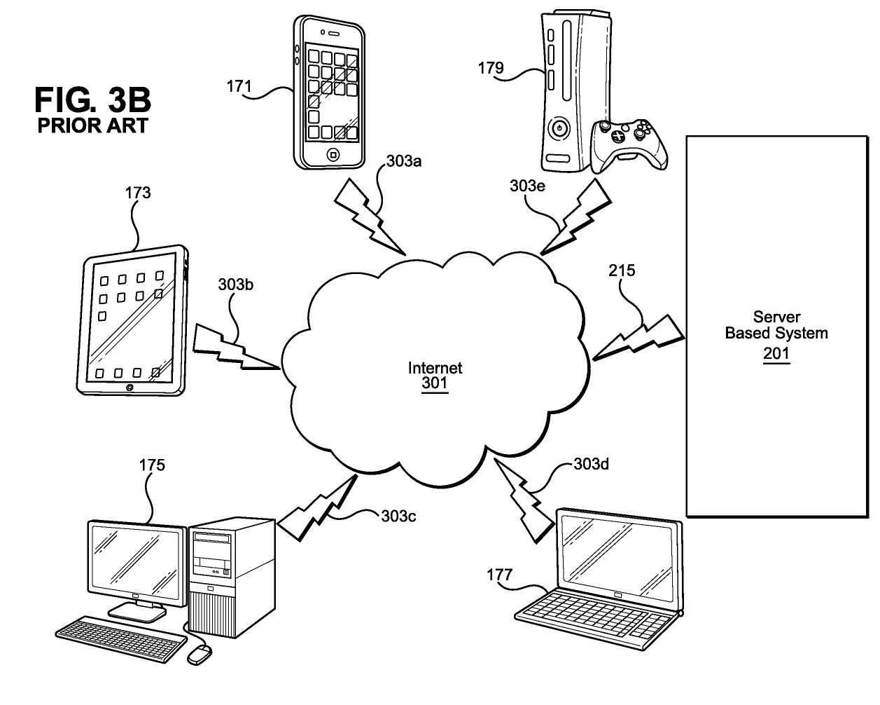

FIG. 3A is a block diagram showing a group of EGMs 101 1-x on a network connection 215 between server based system 201 and each of EGMs 101 1-x. It should be understood that the network may be set up with any number of EGMs that may number into the thousands of machines. Each of EGMs 101 1-x is also connected to external system 203 that may be a player tracking, slot accounting, bonusing or other type of system. Information is communicated between EGMs 101 and server based system 201.

FIG. 3B shows server based system 201 connected to a network with multiple computing devices for playing games. It should be understood that the network shown in FIG. 3B operates in a manner similar to the network of FIG. 3A, except that the computing devices on the network of FIG. 3B are connected over the internet 301 with each device 171-179 connected over a secure connection 303a-e to server based system 201 which connects to the internet over network connection 215. Payments can be made securely over internet 301 using connections 303a-e, and then delivered to an operator over connection 215. Similarly, the game is executed on server based system 201 using a secure RNG with the outcomes being delivered to the individual devices 171-179 over internet 301. Alternatively, the game software or a portion of it may be resident and executed on each device 171-179. Wagers by players and payments to players may be made using accounts set up with an operator of a website on which the games are run.

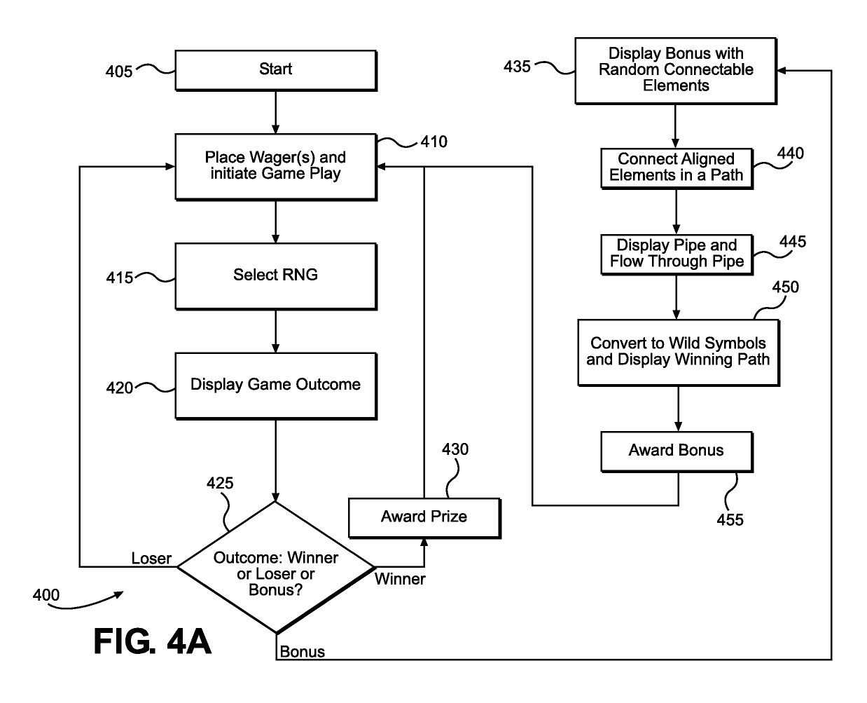

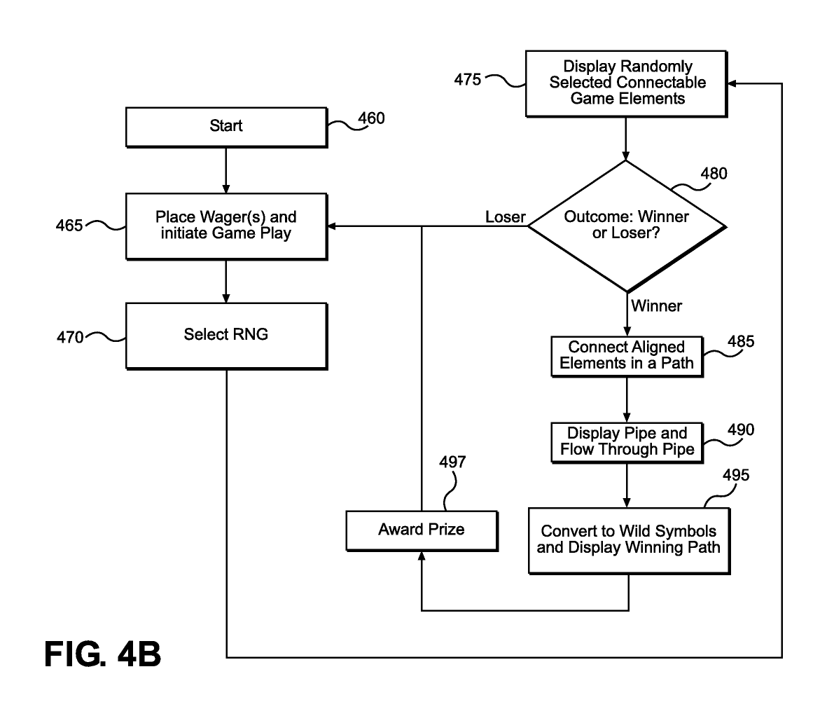

FIG. 4A shows a flow chart 400 of game play where the player plays a game with connectable elements in a bonus game. The base game leading to the bonus game with the connectable elements may be any slot game using spinning reels in a matrix of columns and rows on a set of physical reels or a video display. The base game may alternatively be a poker game, a roulette game, a keno game or any other type of game. The first step of game play on the base game is at start 405 which represents the point when a player sits down at EGM 101 to begin play. The player initially inserts a bill into bill slot 107 or coins into coin head 108 to put credits on the machine. These credits may be displayed to the player on a credit meter which is one of meters 117. For purposes of this description, the base game will be a spinning reel slot game on a video display in which the player selects the number of lines to play and the number of coins per line which is shown on a coins-per-line meter which is one of meters 117. A “total bet” which depends on the number of lines and the number of coins per line is shown on total bet meter which is one of meters 117.

The wager is placed and the game is started using buttons 109 to initiate game play at step 410. An initial game screen for the base game of the slot game shows reels displaying symbols on display 105. For purposes of this description, the reels will be formatted in a matrix of five columns and three rows. It should be understood that any sized matrix of columns and rows would be suitable for implementing the invention.

During game play, appropriate game graphics are shown on display 105 such as spinning reels (or the display of cards in a video poker player), and corresponding game sounds come from speakers 113. At step 415, RNG 135 provides one or more random numbers and a game outcome is chosen. Once the outcome is reached, the outcome is displayed on game display 105 for the player to see at step 420. It is then determined whether the outcome is a winner or loser at step 425. If it is a winning outcome, the player is notified that s/he has won and is awarded a prize at step 430. An indication on display 105 also shows the win and this may be accompanied by celebratory effects and highlighting of the payline and/or symbols on the payline. Credit meter 117 is incremented by the number of coins won and the player is returned to step 410 to play again.

If a losing outcome occurs at step 425, the player is returned to step 410 where s/he may play a new game. Step 425 is also the decision point for triggering a bonus game. A bonus trigger may present itself in a number of different ways, including but not limited to: 1) a pre-defined symbol combination lined up on the payline or elsewhere on the reels such as in a scatter pay that is well known to those in the art of slot machine design; 2) a pre-defined time period measured by EGM 101 or server 201; 3) a random time-period calculated by EGM 101 or server 201; 4) a pre-defined or random dollar amount collected by one or more EGMs 101; 5) a customer loyalty program award; 6) any other mechanism for moving into a bonus or secondary game.

If a bonus trigger occurs at step 425, the bonus game begins. The bonus game includes the display of connectable game elements. These connectable game elements are displayed at step 435 on display 105 with each connectable game element occupying a box in a matrix formed of columns and rows similar to a slot game where symbols are displayed on reels in a matrix of columns and rows. The selection of the particular connectable game element to be shown in each box of the matrix may be random, or may be selected based on an algorithm developed by the game designer. After showing the connectable game elements, each positioned in a box in the matrix of columns and rows, any adjacent game elements that are aligned for connection transform into a connected path at step 440. An optional step is for the connected path to be animated to form a pipe at step 445 with liquid flowing through the pipe to show that the path has been formed. Another optional step is to convert the pipe into a sequence of “wild” symbols at step 450 on which an award is based and that correspond to the base game. It should be understood that the connectable game elements may be designed to be part of the base game theme so that transforming the pathway into wild symbols on a payline is not necessary. Once the path has been formed as a payline or the wild symbol transformation has occurred, an appropriate bonus is awarded at step 455 that corresponds to the path that has been formed. The player is then returned to step 410 to begin the play cycle again.

FIG. 4B shows a flow chart of game play where the player plays a game with connectable elements in a base game. The base game may use a group of spinning reels in a matrix of columns and rows on a set of physical reels or a video display. The first step of game play on the base game is at start 460 which represents the point when a player sits down at EGM 101 to begin play. The player initially inserts a bill into bill slot 107 or coins into coin head 108 to put credits on the machine. These credits may be displayed to the player on a credit meter which is one of meters 117. For purposes of this description, the base game will be a spinning reel slot game on a video display in which the player selects the number of lines to play and the number of coins per line which is shown on a coins-per-line meter which is one of meters 117. A “total bet” which depends on the number of lines and the number of coins per line is shown on total bet meter which is one of meters 117.

The wager is placed and the game is started using buttons 109 to initiate game play at step 465. A game screen for the game shows the slot game with reels that display different connectable game elements on display 105. For purposes of this description, the reels will be formatted in a matrix of five columns and three rows. It should be understood that any sized matrix of columns and rows would be suitable for implementing the invention.

During game play, appropriate game graphics are shown on display 105 such as spinning reels, and corresponding game sounds come from speakers 113. At step 470, RNG 135 provides one or more random numbers and a game outcome is chosen. Once the outcome is reached, the outcome with a matrix of boxes each containing a randomly selected connectable game element is displayed on game display 105 for the player to see at step 475. It is then determined whether the outcome is a winner or loser at step 480. If it is a losing outcome, the player is notified that s/he has lost and is returned to begin play of a new game at step 465. If the outcome is a winner in which connectable game elements are aligned, those connectable game elements are connected at step 485 on display 105 to show the win(s) and this may be accompanied by celebratory effects and highlighting of the connectable game elements in a path or payline. As an option, the path may be transformed into a pipe at step 490 through which animated liquid may flow. Another option is for the boxes in the path to be converted to wild symbols or other winning symbols to be displayed on display 105 at step 495. Credit meter 117 is incremented by the number of coins won and the player is awarded a prize at step 497. It should be understood that alignment of connectable game elements may result in the formation of multiple winning paths, each of which may generate an award to a player.

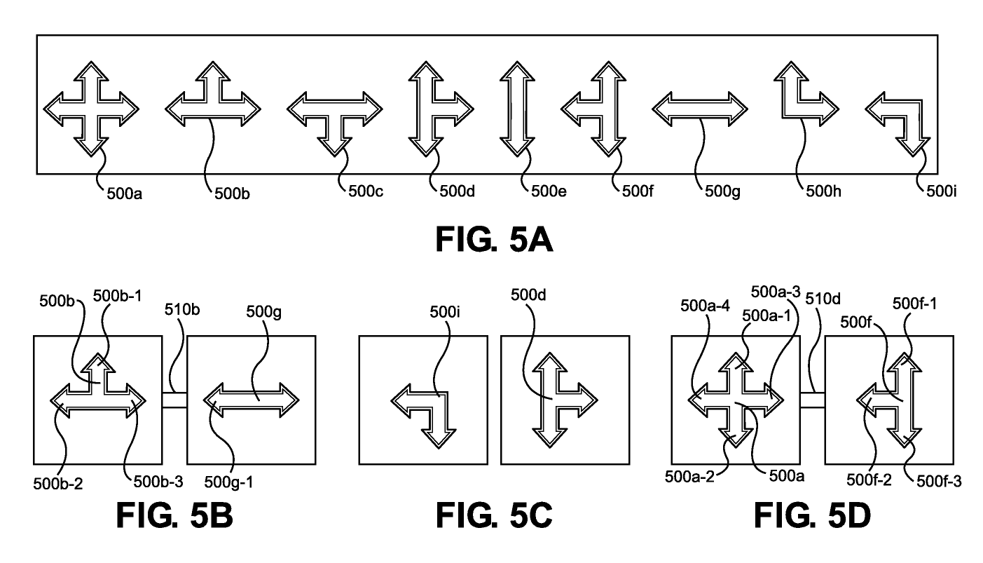

FIG. 5A shows a set of connectable game elements for use in the game described with respect to the flowcharts of FIG. 4A and FIG. 4B and bearing reference numbers 500a-i. Each connectable game element 500 has one or more ends that when aligned properly with the end of an adjacent connectable game element may form a connection between those adjacent elements. For example, FIGS. 5B-5D show three different adjacent connectable game element pairs. In FIG. 5B, adjacent game elements 500b and 500g are aligned for connection as end 500b-3 of game element 500b is aligned with end 500g-1 of game element 500g. Therefore, a connection 510b may be formed between game element 500b and game element 500g. In FIG. 5c, the adjacent game elements 500i and 500d do not have ends that are aligned. Therefore, they may not form a connection. FIG. 5D shows adjacent game elements 500a and 500f where end 500a-3 and end 500f-2 are aligned. Therefore, a connection 510d may be formed between game element 500a and game element 500f.

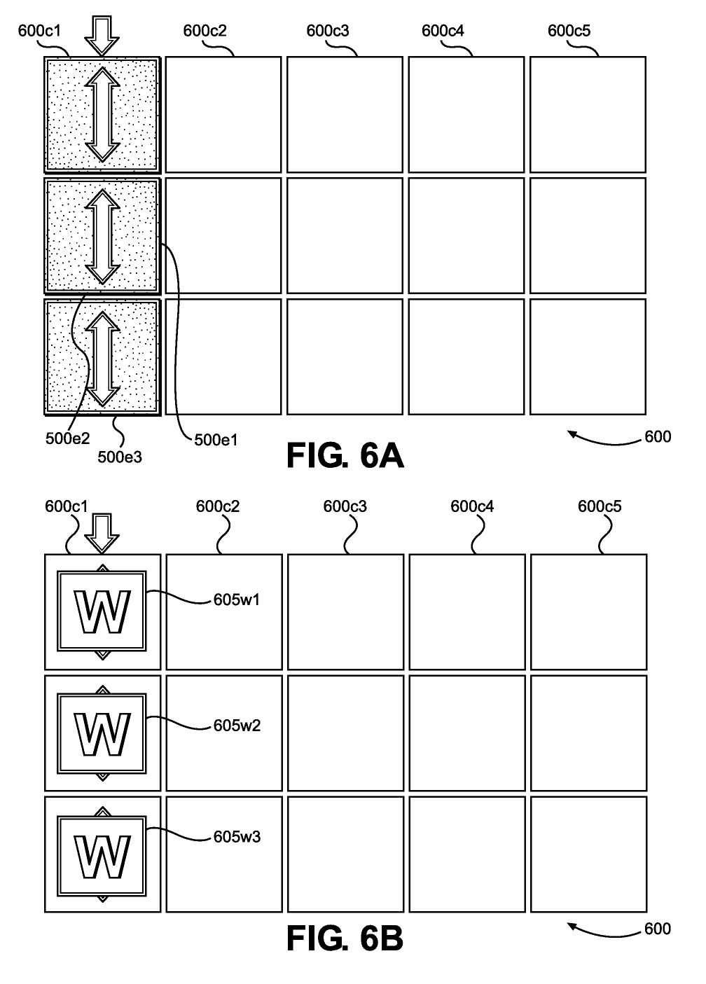

If multiple alignments of connectable ends of a group of adjacent game elements across a matrix occur, the connections between those elements may form a path or pathway, which may also be referred to as a pipe. In FIG. 6A, a slot bonus game is played on matrix 600 on display 105 of EGM 101. A first column 600-c1 forms a path where three vertical connectable game elements 500e1, 500e2 and 500e3 are lined up vertically with their respective ends aligned. The path is highlighted across the vertical boxes of the matrix and the other columns 600c-2-600c-5 are left blank so that it easy to see how the path is formed. Once a path is formed within matrix 600, an animated pipe with liquid flowing through it may be displayed and then the pipe may be transformed as shown in FIG. 6B with the connectable game elements on the highlighted pathway becoming wild symbols 605w1-605w3. After the transformation to the wild symbols occurs, the player is provided with the appropriate award for the bonus win and may begin play of a new game.

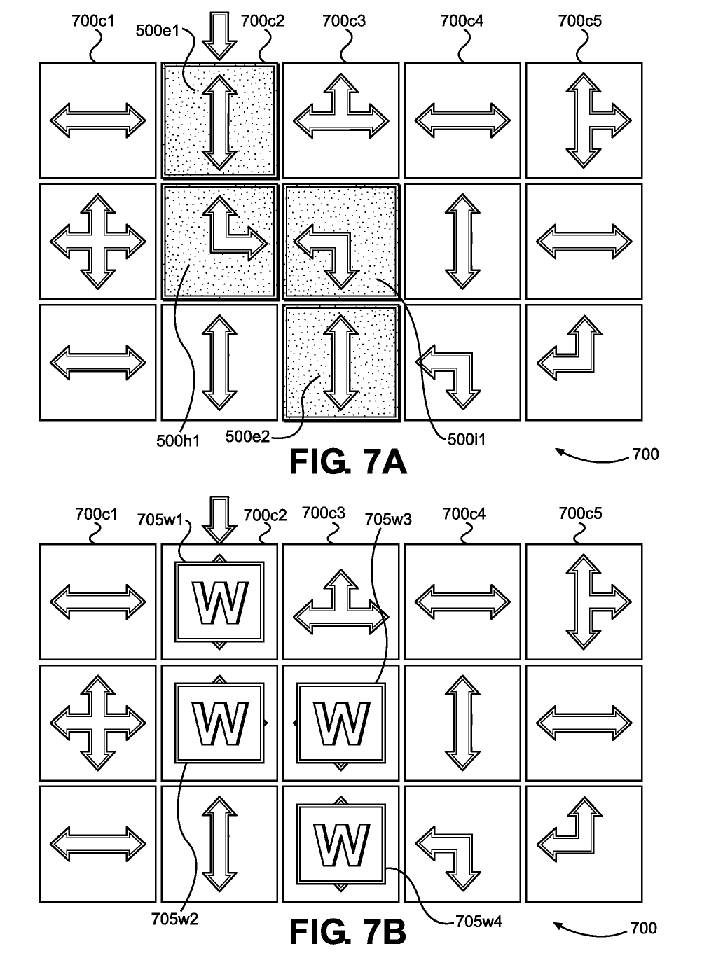

FIGS. 7A-7B show another example of screen shots of game play where the player plays a game with connectable game elements. FIGS. 7A-7B follow a similar method as that of FIGS. 6A-6B, except in the case of FIGS. 7A-7B, matrix 700 is filled in with connectable game elements. As can be seen in FIG. 7A, a vertical path is formed from top to bottom including four boxes that go from the second column 700c2 down two rows, across one box to the right to column 700c3 and down one row. The path is formed from four aligned game elements 500e1, 500h1, 500i1 and 500e2. The transformation of the connectable game elements to wild symbols is shown in FIG. 7B where the connectable game elements 500e1, 500h1, 500i1 and 500e2 on the highlighted pathway become wild symbols 705w1-705w4. All of the other connectable game elements shown on the matrix may fade out or simply be left in place. After the transformation to the wild symbols occurs, the player is provided with the appropriate award for the bonus win and may begin play of a new game.

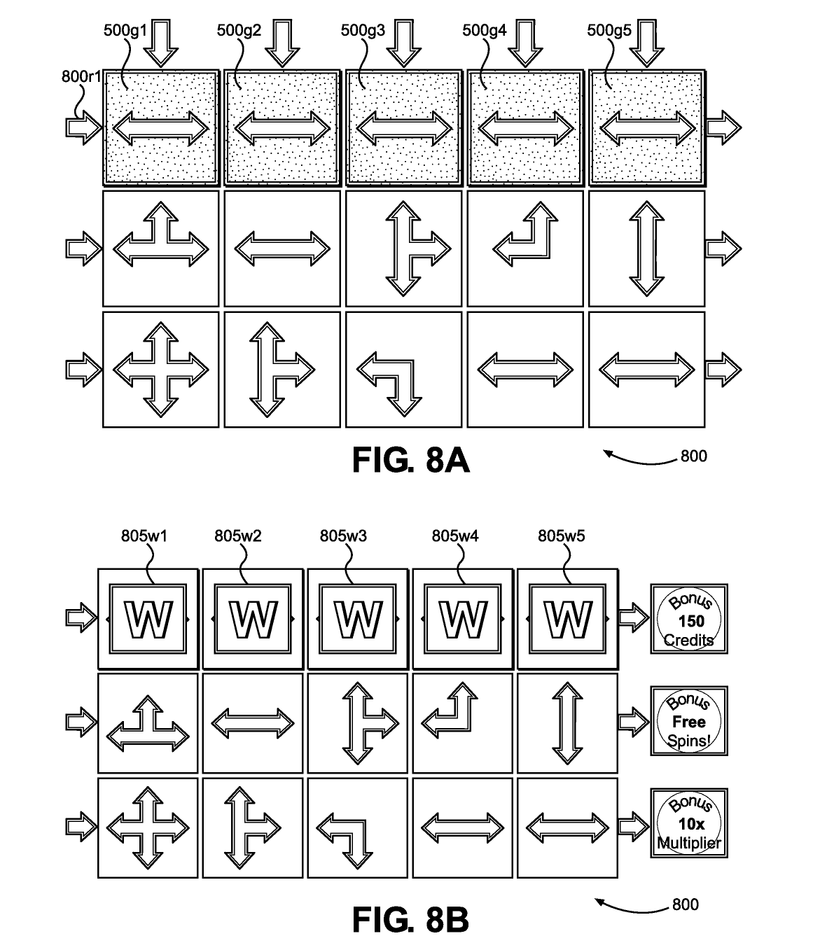

A path may be vertically oriented from top to bottom like the paths in FIGS. 6A-6B and FIGS. 7A-7B, or from top to bottom. The path may also be straight like the path in FIGS. 6A-6B or it may be more circuitous like the path of FIGS. 7A-7B. It may also be horizontally oriented from left to right like the path in FIG. 8A or from right to left. It's also possible to provide a path that: 1) follows the outside boxes of the matrix; or 2) one that is oriented diagonally from the top left corner to the bottom right corner or from the top right corner to the bottom left corner. A path may be any shape defined by the designer, and may even include special connectable game elements that act as “wild” elements that connect in any direction. Once the connectable game elements are aligned and connected, they may become pipes that allow an animation of flowing liquid in, through and/or around the connected pipe. Alternatively, a gas may be shown that floats in an upward direction. Award amounts or other animations may be added to the flow for celebratory effect.

Different rules may be formulated for the formation of a path for any given game. For example, the path may be transformed into a pipe in which liquid may only flow from top to bottom or only from left to right entering at the top and exiting at the bottom. Alternatively, the liquid may be a gas that rises up from the bottom and may only flow from bottom to top or in a right to left direction. Such limitations are useful to a game designer who may be working to limit the number of possible outcomes so that different prize levels may be offered for different paths.

FIGS. 8A-8B show another example of screen shots of game play where the player plays a game with connectable game elements. FIGS. 8A-8B follow a similar method as that of FIGS. 6A-6B and FIGS. 7A-7B, except in the case of FIGS. 8A-8B, matrix 800 is played in a horizontal orientation. As can be seen in FIG. 8A, a horizontal path is formed from left to right including five boxes that form a straight line across row 800r1. The path is formed from five aligned game elements 500g1, 500g2, 500g3, 500g4 and 500g5. The transformation of the connectable game elements to wild symbols is shown in FIG. 8B where the connectable game elements 500g1, 500g21, 500g3, 500g4 and 500g5 on the highlighted pathway become wild symbols 805w1-805w5. All of the other connectable game elements shown on the matrix may fade out or simply be left in place.

It will be apparent that it is more difficult to form a horizontal path made up of five boxes in matrix 800 than it would be to form a vertical path formed of three or four boxes as shown in matrix 600 or matrix 700, respectively. The greater the number of boxes required to form a path, the lower the probability of achieving a completed path, and therefore, the greater the award that may be paid to a player for doing so. After the transformation to the wild symbols occurs in FIG. 8B, the player is provided with the appropriate award for the bonus win and may begin play of a new game.

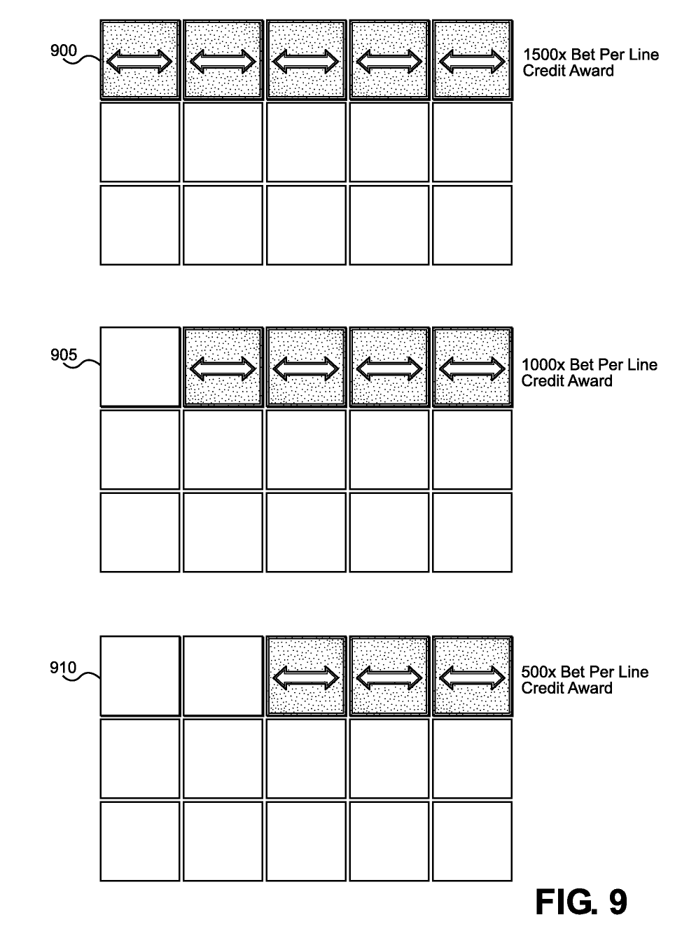

As an alternative to providing credits for completing a path or pipe, a multiplier may be provided to the player that multiplies the credits awarded for a winning combination on the base game. FIG. 9 shows some examples of such multipliers. As can be seen in FIG. 9, three different multipliers are available in this particular game configuration for connecting paths of different lengths: 1) 1,500 times bet per line multiplier for a pathway of five horizontal connected game elements 900; 2) 1,000 times multiplier for a pathway of four horizontal connected game elements 905; and 3) 500 times bet per line multiplier for a pathway of three horizontal connected game elements 910. As will be understood from the description and the figures presented herein, the simple path configurations of FIG. 9 are representative only and any of the connectable game elements, or others that are not shown, may be used to form a pathway.

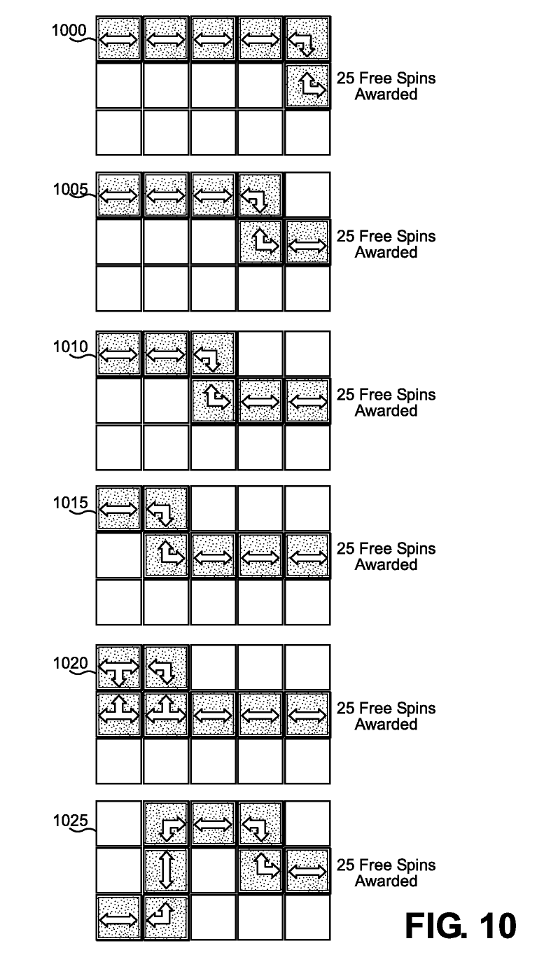

As another alternative to providing credits or a multiplier for completing a path or pipe, free spins may be provided to the player for completing a path. FIG. 10 shows examples of free spin awards. As can be seen in FIG. 10, six different free spin awards are available in this particular game configuration for connecting different paths 1000-1025. As will be understood from the description and the figures presented herein, the path configurations of FIG. 10 are representative only and any of the connectable game elements, or others that are not shown, may be used to form a pathway.

While the invention has been described with respect to the figures, it will be appreciated that many modifications and changes may be made by those skilled in the art without departing from the spirit of the invention. For example, any particular game incorporating the invention may have paths of different configurations and/or lengths. Also, the connectable game elements may be designed differently and be provided as a set that includes any number of possible connectable game elements. For example a connectable game element may have ends that align for connection diagonally in an “X” shape between boxes adjacent to each other at corners in the matrix. Also, while the formation of a path has been described as a bonus or multiplier, the random selection of connectable game elements may be played as a base or stand-alone game. Any variation and derivation from the above description and drawings are included in the scope of the present invention as defined by the claims.

What is claimed is:

1. An electronic gaming machine (“EGM”) on which a player plays a game, comprising:
a random number generator (“RNG”) for generating random numbers that determine the outcome of the game and that correspond to a predefined set of game outcomes including winning and losing outcomes;
a display for displaying game play including game outcomes to a player;
a controller which receives the random numbers and controls game play on the EGM wherein for a predefined set of outcomes, the player is provided with a plurality of connectable game elements positioned in rows and columns on the display, each particular connectable game element having one or more directionally connectable ends, wherein alignment between a connectable end of a first connectable game element and a connectable end of a second connectable game element results in a connection between those elements; and
a path shown on the display formed between at least two connectable game elements that when being of a predefined configuration results in an award to the player.

2. The system of claim 1 wherein the formation of a path results in the player being provided an award from the group comprising at least one of the following: (a) one or more free plays; (b) one or more bonus game plays; (c) a multiplier; (d) a credit award; (e) a cash award; or (f) a non-cash award.

3. The system of claim 2 wherein the multiplier is predefined based on the number of connectable game elements forming the path.

4. The system of claim 1 including a wagering component that accepts a wager from a player enabling the player to play the game.

5. The system of claim 1 wherein the path is a conduit that provides an animated flow on the display.

6. The system of claim 5 wherein the animated flow moves through the path in one or more predefined directions.

7. The system of claim 1 wherein the placement of connectable game elements in rows and columns on the display is randomly determined using random numbers provided by the RNG.

8. The system of claim 1 further comprising the formation of a plurality of paths formed where at least two groups of connectable game elements are aligned.

9. The system of claim 1 wherein at least one connectable game element has at least three ends, and further wherein the at least one connectable game element with at least three ends connects to at least three other connectable game elements forming at least two paths that intersect at the at least one connectable game element having at least three ends.

10. The system of claim 1 wherein the path is of the type selected from the group comprising: a) a line that is primarily vertically oriented; b) a line that is primarily horizontally oriented; c) a line that is primarily diagonally oriented; d) a predefined shape; or e) a scatter pattern.

11. A method of playing a game on an electronic gaming machine (“EGM”) having a controller that receives random numbers from a random number generator and a display, comprising:
providing a plurality of game outcomes, wherein for a predefined set of outcomes the player is provided with a plurality of connectable game elements positioned in rows and columns on the display, each particular connectable game element having one or more directionally connectable ends;
forming a connection between aligned ends of the connectable game elements on the display;
forming a path comprising a plurality of connectable game elements that have been connected on the display; and
awarding a player for achieving a path of a predefined configuration.

12. The method of claim 11 wherein the award is one of the types from the group comprising: (a) one or more free plays; (b) one or more bonus game plays; (c) a multiplier; (d) a credit award; (e) a cash award; or (f) a non-cash award.

13. The method of claim 12 wherein the multiplier is predefined based on the number of connectable game elements forming the path.

14. The method of claim 11 further comprising placing a wager to initiate play of the game.

15. The method of claim 11 wherein the path is a conduit that provides an animated flow on the display.

16. The method of claim 15 wherein the animated flow moves through the path in one or more predefined directions.

17. The method of claim 11 further comprising forming of a plurality of paths where at least two groups of connectable game elements are aligned.

18. The method of claim 11 wherein at least one connectable game element has at least three ends, and further wherein the at least one connectable game element with at least three ends connects to at least three other connectable game elements forming at least two paths that intersect at the at least one connectable game element having at least three ends.

19. The method of claim 11 wherein the placement of connectable game elements in rows and columns on the display is randomly determined using random numbers provided by the RNG.

20. The method of claim 11 wherein the path is of the type selected from the group comprising: a) a line that is primarily vertically oriented; b) a line that is primarily horizontally oriented; c) a line that is primarily diagonally oriented; d) a shape; or e) a scattered pattern.
